(19) United States
(12) Patent Application Publication
(10) Pub. No.: US 2020/0175408 A1
(43) Pub. Date: Jun. 4, 2020

(54) SEQUENTIAL DEEP LAYERS USED IN MACHINE LEARNING

(71) Applicant: INTERNATIONAL BUSINESS MACHINES CORPORATION, Armonk, NY (US)

(72) Inventors: Aaron K. BAUGHMAN, Silver Spring, MD (US); Craig M. TRIM, Ventura, CA (US); Todd Russell WHITMAN, Bethany, CT (US); Martin G. KEEN, Cary, NC (US)

(21) Appl. No.: 16/204,784

(22) Filed: Nov. 29, 2018

(51) Int. Cl. G06N 10/00; G06N 20/20; G06N 3/04

(52) U.S. Cl. CPC G06N 10/00; G06N 3/04; G06N 20/20

(57) ABSTRACT

Methods and systems for sequential deep layers used in deep learning are disclosed. A method includes: selecting, by a computing device, layers from a plurality of external deep learning models; concatenating, by the computing device, the selected layers from the plurality of external deep learning models to form a core deep learning model; training, by the computing device, the core deep learning model; and synchronizing, by the computing device, layers in the core deep learning model with the layers from the plurality of external deep learning models using quantum entanglement.

### BACKGROUND

The present invention generally relates to computing devices and, more particularly, to methods and systems for sequential deep layers used in deep learning.

Deep learning algorithms may use sequential data to learn patterns and perform image recognition. Two or more deep learning algorithms are typically combined by creating a network or graph that describes how the layers in the two or more deep learning algorithms interact with each other. However, the process of creating the network or graph is challenging and error-prone. Additionally, changes in the underlying deep learning algorithms will typically break the network or graph.

Additionally, with conventional deep learning models, with the use of conventional transfer learning and combinatorial generation of training data, domain adaptation, and custom training are difficult. Furthermore, conventional deep learning algorithms that use sequential data to learn patterns perform poorly on unseen sequences. Techniques such as long short-term memory (LSTM) and gated recurrent units (GRUs) use proximity to other patterns to help determine a current pattern. Additionally, the connectionist temporal classification (CTC) loss function further adds back propagation penalties based on a sequence of patterns. However, the combination of sequence layers and sequence-based loss functions has created a problem that mostly unseen patterns are not generally recognized.

### SUMMARY

In a first aspect of the invention, there is a method that includes: selecting, by a computing device, layers from a plurality of external deep learning models; concatenating, by the computing device, the selected layers from the plurality of external deep learning models to form a core deep learning model; training, by the computing device, the core deep learning model; and synchronizing, by the computing device, layers in the core deep learning model with the layers from the plurality of external deep learning models using quantum entanglement. This aspect of the invention addresses the above-mentioned shortcomings associated with conventional deep learning algorithms by combining multiple deep learning algorithms without using a network.

In another aspect of the invention, there is a computer program product that includes a computer readable storage medium having program instructions embodied therewith. The program instructions are executable by a computing device to cause the computing device to: select layers from a plurality of external deep learning models based on testing using unseen patterns; concatenate the selected layers from the plurality of external deep learning models to form a core deep learning model; and synchronize layers in the core deep learning model with the layers from the plurality of external deep learning models using quantum entanglement. This aspect of the invention addresses the above-mentioned shortcomings associated with conventional deep learning algorithms by combining multiple deep learning algorithms without using a network.

In another aspect of the invention, there is a system that includes: a hardware processor, a computer readable memory, and a computer readable storage medium associated with a computing device; program instructions to select layers from a plurality of external deep learning models; program instructions to concatenate the selected layers from the plurality of external deep learning models to form a core deep learning model; program instructions to train the core deep learning model; and program instructions to synchronize layers in the core deep learning model with the layers from the plurality of external deep learning models using quantum entanglement, wherein the program instructions are stored on the computer readable storage medium for execution by the hardware processor via the computer readable memory. This aspect of the invention addresses the above-mentioned shortcomings associated with conventional deep learning algorithms by combining multiple deep learning algorithms without using a network.

In another aspect of the invention, there is method that includes: concatenating, by a computing device, at least two gated recurrent units from at least two deep learning models to form a core deep learning model; performing partial domain adaptation, by the computing device, on the core deep learning model; and updating, by the computing device, weights used in the core deep learning model by combining new incoming weights from the at least two deep learning models with stored weights for the core deep learning model. This aspect of the invention addresses the above-mentioned shortcomings associated with conventional deep learning algorithms by combining multiple deep learning algorithms without using a network.

In another aspect of the invention, there is a computer program product that includes a computer readable storage medium having program instructions embodied therewith. The program instructions are executable by a computing device to cause the computing device to: concatenate at least two gated recurrent units from at least two deep learning models to form a core deep learning model; perform partial domain adaptation on the core deep learning model; store weights used in the core deep learning model; and update weights used in the core deep learning model by combining new incoming weights from the at least two deep learning models with the stored weights. This aspect of the invention addresses the above-mentioned shortcomings associated with conventional deep learning algorithms by combining multiple deep learning algorithms without using a network.

In an optional aspect of the invention, the layers from the plurality of external deep learning models are tested using unseen patterns. In another optional aspect of the invention, the layers from the plurality of external deep learning models are selected based on a result of the testing. In another optional aspect of the invention, weights used in the core deep learning model are stored. In another optional aspect of the invention, new incoming weights are received from the external deep learning models. In another optional aspect of the invention, the synchronizing the layers in the core deep learning model with the layers from the plurality of external deep learning models using quantum entanglement comprises updating the weights used in the core deep learning model by combining the new incoming weights with the stored weights. These optional aspects of the invention address the above-mentioned shortcomings by providing a core deep learning model that is untethered from a network through entanglement and that allows for transfer of weights without network lag.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 depicts an illustrative environment in accordance with aspects of the invention.

FIG. 5 depicts a flowchart of an exemplary method performed in accordance with aspects of the invention.

FIG. 6 depicts an exemplary core deep learning model in accordance with aspects of the invention.

FIG. 7 depicts another exemplary core deep learning model in accordance with aspects of the invention.

### DETAILED DESCRIPTION

The present invention generally relates to computing devices and, more particularly, to methods and systems for sequential deep layers used in deep learning. As described herein, aspects of the invention include a method and system for combining different deep learning models together, without using a network (e.g., using edge models), to increase a number of recognized classes within sequence models. In embodiments, a deep learning model is chained together with multiple other deep learning models and used within different domains.

Furthermore, in embodiments, entangled model weights are generated based on custom weights on the cloud. Additionally, embodiments provide for external local feature diffusion into an active deep learning algorithm, chained polymorphic shared layers through the cloud, and partial domain adaptation of polymorphic layers.

Embodiments address the above-mentioned problems associated with conventional deep learning models by untethering deep learning models from a network through entanglement. Additionally, embodiments address the lack of generalization within sequence-oriented layers and loss functions. Accordingly, embodiments improve the functioning of a computer by providing methods and systems for sequential deep layers with sequence-oriented loss function generalization. In particular, embodiments improve software by providing methods and systems for combining different deep learning models together, without using a network (e.g., using edge models), to increase a number of recognized classes within sequence models as well as for chaining a deep learning model together with multiple other deep learning models for use within different domains. Furthermore, embodiments improve software by leveraging other model weights that were trained in completely different spaces, performing deep learning on an edge server, and using chained models, polymorphic models, and local weight caching. Additionally, implementations of the invention use techniques that are, by definition, rooted in computer technology (e.g., machine learning, deep learning, LSTM, GRUs, and CTC).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

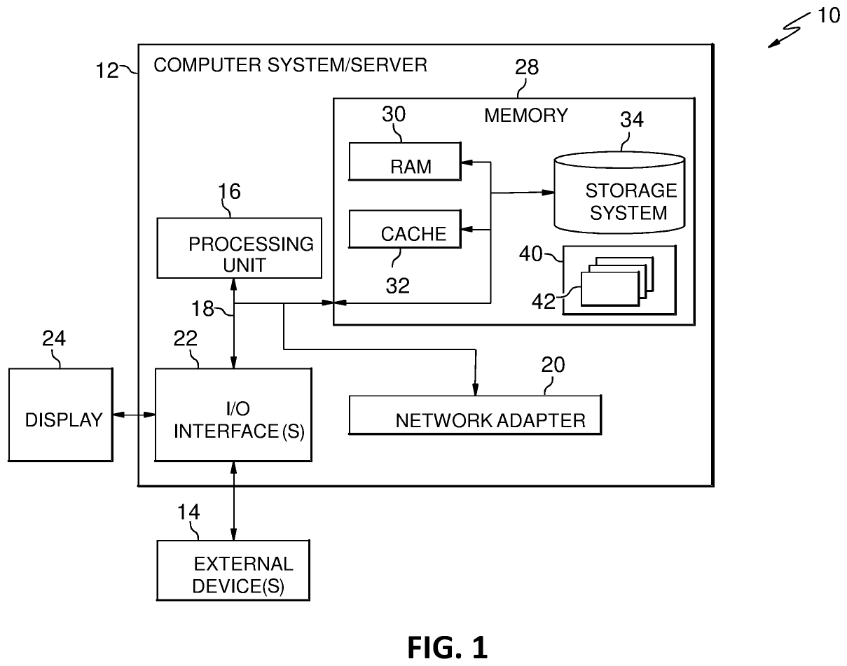

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

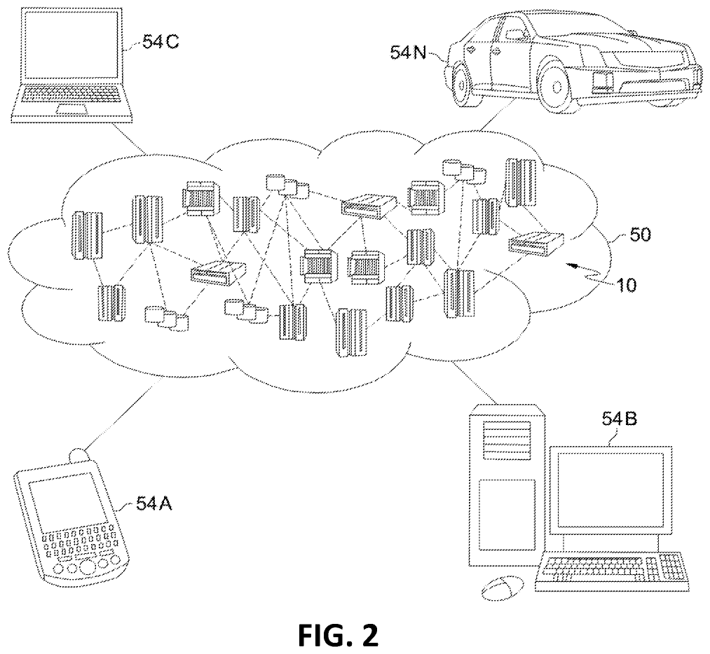

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

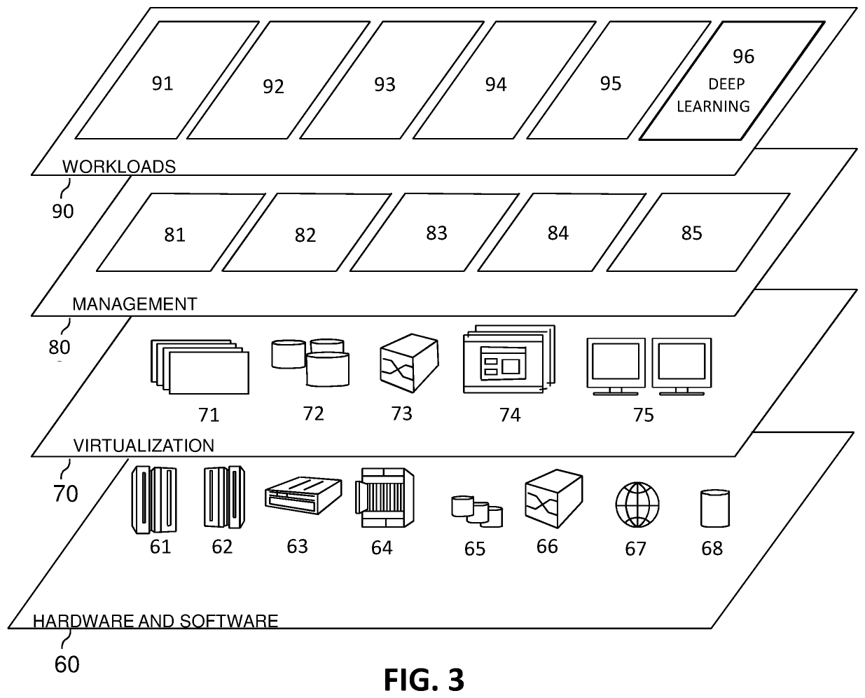

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and deep learning 96.

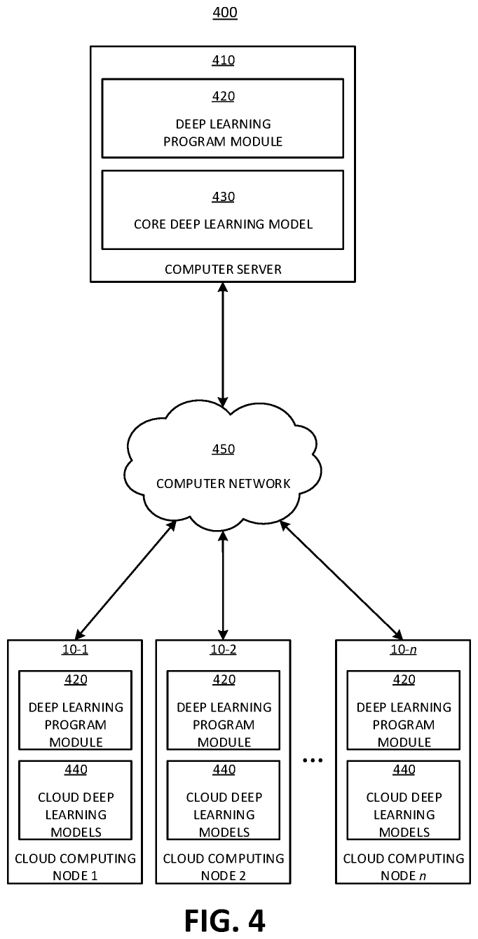

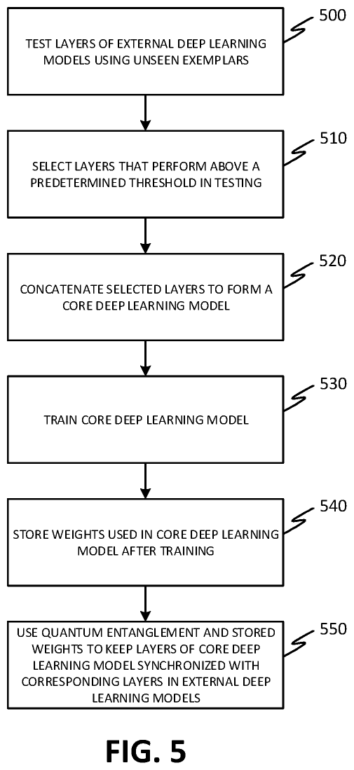

Referring back to FIG. 1, the program/utility 40 may include one or more program modules 42 that generally carry out the functions and/or methodologies of embodiments of the invention as described herein (e.g., such as the functionality provided by deep learning 96). Specifically, the program modules 42 may perform deep learning using sequential deep layers with sequence-oriented loss function generalization. Other functionalities of the program modules 42 are described further herein such that the program modules 42 are not limited to the functions described above. Moreover, it is noted that some of the modules 42 can be implemented within the infrastructure shown in FIGS. 1-3. For example, the modules 42 may be representative of a deep learning program module 420 as shown in FIGS. 4 and 5.

FIG. 4 depicts an illustrative environment 400 in accordance with aspects of the invention. As shown, the environment 400 comprises a computer server 410 and a plurality of cloud computing nodes 10-1, 10-2, . . . , 10-n which are in communication via a computer network 450. In embodiments, the computer network 450 is any suitable network including any combination of a LAN, WAN, or the Internet. In embodiments, the computer server 410 and the plurality of cloud computing nodes 10-1, 10-2, . . . , 10-n are physically collocated, or, more typically, are situated in separate physical locations.

The quantity of devices and/or networks in the environment 400 is not limited to what is shown in FIG. 4. In practice, the environment 400 may include additional devices and/or networks; fewer devices and/or networks; different devices and/or networks; or differently arranged devices and/or networks than illustrated in FIG. 4. Also, in some implementations, one or more of the devices of the environment 400 may perform one or more functions described as being performed by another one or more of the devices of the environment 400.

In embodiments, the computer server 410 is a computer device comprising one or more elements of the computer system/server 12 (as shown in FIG. 1). In particular, the computer server 410 is implemented as hardware and/or software using components such as mainframes; RISC (Reduced Instruction Set Computer) architecture based servers; servers; blade servers; storage devices; networks and networking components; virtual servers; virtual storage; virtual networks, including virtual private networks; virtual applications and operating systems; and virtual clients.

In embodiments, the computer server 410 includes a deep learning program module 420, which includes hardware and/or software such as one or more of the program modules 42 shown in FIG. 1. The computer server 410 also includes a core deep learning model 430. The deep learning program module 420 includes program instructions for concatenating layers from different deep learning models to form the core deep learning model 430. In embodiments, the program instructions included in the deep learning program module 420 of the computer server 410 are executed by one or more hardware processors.

Still referring to FIG. 4, in embodiments, each of the cloud computing nodes 10-1, 10-2, . . . , 10-n may be implemented as hardware and/or software using components such as mainframes 61; RISC (Reduced Instruction Set Computer) architecture based servers 62; servers 63; blade servers 64; storage devices 65; networks and networking components 66; virtual servers 71; virtual storage 72; virtual networks 73, including virtual private networks; virtual applications and operating systems 74; and virtual clients 75 shown in FIG. 3. In embodiments, each of the cloud computing nodes 10-1, 10-2, . . . , 10-n includes the deep learning program module 420 and cloud deep learning models 440, which are deep learning models such as deep neural networks with multiple layers between the input and output layers.

FIG. 5 depicts a flowchart of an exemplary method performed by the deep learning program module 420 of the computer server 410 (and of the cloud computing nodes 10-1, 10-2, . . . , 10-n) in accordance with aspects of the invention. The steps of the method are performed in the environment of FIG. 4 and are described with reference to the elements shown in FIG. 4.

At step 500, the computer server 410 tests layers of external deep learning models using unseen exemplars. In embodiments, the deep learning program module 420 performs brute force testing on layers of two or more external deep learning models, such as the cloud deep learning models 440 on the cloud computing nodes 10-1, 10-2, . . . , 10-n. In embodiments, the layers of the external deep learning models that are tested at step 500 are gated recurrent units (GRUs).

Still referring to step 500, in embodiments, the testing performed by the deep learning program module 420 includes feeding testing data including unseen exemplars (i.e., data/patterns not previously seen by the external deep learning models) into the layers of the external deep learning models and determining whether or not the external deep learning models are able to correctly recognize (classify) the testing data. In an example, a layer in an external deep learning model may classify images as “animals” or “not animals.” In this example, the testing performed at step 500 includes feeding testing data including various images not previously seen by the external deep learning model into the layer and determining a proportion of correct classifications to incorrect classifications made by the layer in the external deep learning model.

At step 510, the computer server 410 selects layers that perform above a predetermined threshold in the testing. In embodiments, the deep learning program module 420 selects layers in the external deep learning models that are able to correctly recognize the unseen exemplars with a confidence level (score) above the predetermined threshold, based on the testing at step 500. Other layers in the external deep learning models that are unable to correctly recognize the unseen exemplars with a confidence level (score) above the predetermined threshold are discarded by the deep learning program module 420.

Still referring to step 510, layers in different external deep learning models may perform the same classification (e.g., “animal” or “not animal,” as in the example above). In this case, the deep learning program module 420 selects the layer that is able to correctly recognize the unseen exemplars with the highest confidence level and discards the other layers as superfluous.

At step 520, the computer server 410 concatenates the selected layers to form the core deep learning model 430. In embodiments, the deep learning program module 420 concatenates the layers from the external deep learning models selected at step 510 to form the core deep learning model 430. In particular, in concatenating the selected layers to form the core deep learning model 430, the deep learning program module 420 maintains the ordering of layers from the external deep learning models and also reuses the weights from the external deep learning models.

In an example, each of the external deep learning models may have three layers, including a first layer that performs coarse-grained recognition, a second layer that performs medium-grained recognition, and a third layer that performs fine-grained recognition. The deep learning program module 420 uses a first layer selected from one of the external deep learning models as a first layer in the core deep learning model 430, a second layer selected from one of the external deep learning models as a second layer in the core deep learning model 430, and a third layer selected from one of the external deep learning models as a third layer in the core deep learning model 430.

In the event that the selected layers include multiple first layers, second layers, or third layers, then the deep learning program module 420 concatenates those layers in a random order in the core deep learning model 430. Alternatively, the deep learning program module 420 creates an ensemble concatenation including multiple variations and then uses the concatenation that performs best based on a given loss function as the core deep learning model 430.

At step 530, the computer server 410 trains the core deep learning model 430. In embodiments, the deep learning program module 420 uses deep learning techniques to train the core deep learning model 430 created at step 520 using training (test) data comprising various exemplars. During the training, the deep learning program module 420 performs partial domain adaptation on the core deep learning model 430 by adjusting the weights used in each of the layers from their initial values (taken from the external deep learning models) to improve the recognition performance (e.g., a confidence level) of each layer.

At step 540, the computer server 410 stores the weights used in the core deep learning model 430 after the training. In embodiments, the deep learning program module 420 stores the weights used in each layer of the core deep learning model 430 after the training (including partial domain adaptation) is performed at step 530. In other embodiments, the deep learning program module 420 saves each layer of the core deep learning model 430 after the training is performed at step 530.

At step 550, the computer server 410 uses quantum entanglement and the stored weights to keep the layers of the core deep learning model 430 synchronized with the corresponding layers in the external deep learning models. In embodiments, the deep learning program module 420 uses quantum entanglement to update the core deep learning model 430 with new incoming weights from the external deep learning models, which themselves have been trained (resulting in updated weights) since the point at which their layers were concatenated at step 520 to form the core deep learning model 430.

In updating the core deep learning model 430 with the new incoming weights at step 550, the deep learning program module 420 discounts the incoming weights using a time weight factor. In particular, as more time elapses since the selected layers from the external deep learning models were concatenated at step 520 to form the core deep learning model 430, more training is performed at step 530 and therefore the core deep learning model drifts farther from the weights used in the external deep learning models. Accordingly, the time weight factor is used to provide a discount to the incoming weights that increases as more time elapses.

Still referring to step 550, in embodiments, the deep learning program module 420 updates each layer in the core deep learning model 430 by combining the incoming weights from the corresponding layers in the external deep learning models, discounted based on the time weight factor, with the weights stored at step 540. Accordingly, the deep learning program module 420 keeps the layers in the core deep learning model 430 synchronized with the corresponding layers in the external deep learning models using quantum entanglement. The flow then returns to step 530, and additional training is performed by the deep learning program module 420.

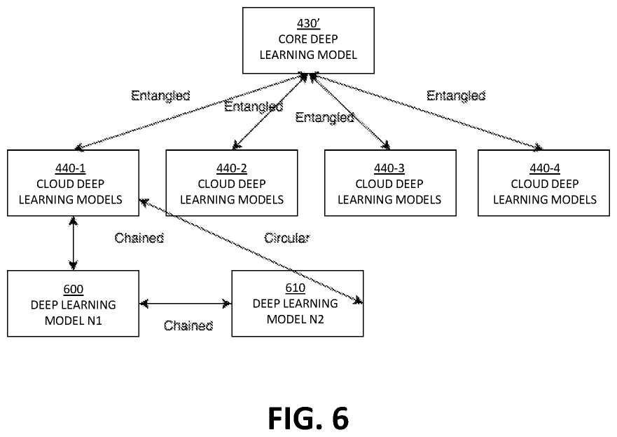

FIG. 6 depicts an exemplary core deep learning model 430′ in accordance with aspects of the invention. The core deep learning model 430′ is a concatenation of layers from the cloud deep learning models 440-1, 440-2, 440-3, 440-4. The cloud deep learning models 440-1, 440-2, 440-3, 440-4 are entangled with the core deep learning model 430′ such that the deep learning program module 420 keeps the layers in the core deep learning model 430′ synchronized with the corresponding layers in the cloud deep learning models 440-1, 440-2, 440-3, 440-4. Additionally, the cloud deep learning model 440-1 is chained with deep learning model N1 600, which is chained with deep learning model N2 610, which has a circular relation to the cloud deep learning model 440-1.

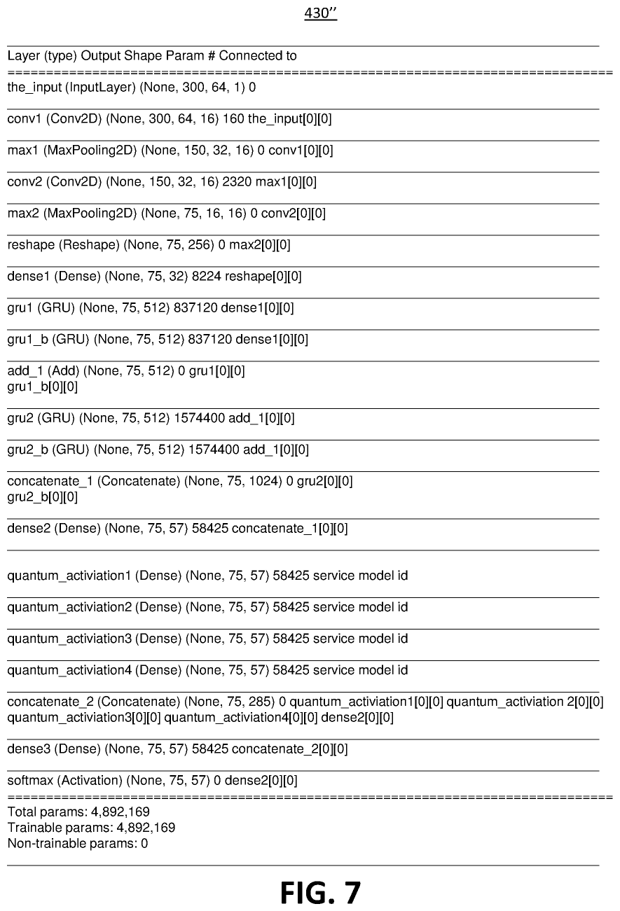

FIG. 7 depicts an exemplary core deep learning model 430″ in accordance with aspects of the invention. The core deep learning model 430″ uses four GRUs that go in both directions. The four used layers are then catenated together. The unseen exemplars are tested on external models using machine learning or customized models that are shared. If those unseen exemplars are recognized, then those model layers are included into the core deep learning model 430″ as shown in FIG. 7. During training, the included model layers are held constant and kept in sync with the weights of the model on the cloud through quantum entanglement. In this way, there is model transfer of weights without any network lag. Each of the layers that are shared goes through partial domain adaptation. When this happens, the modified layers are saved locally so that when the core deep learning model 430″ is updated through entanglement, the previous weights may be included. A time weight from entanglement updates determines the weight of the entangled weights.

Accordingly, it is understood from the foregoing description that embodiments of the invention provide a method of concatenating one or more layers, determining whether there are unseen patterns in the one or more concatenated layers, and in response to determining that there are unseen patterns, training a deep learning model on the unseen patterns. Additionally, in embodiments, the method also includes syncing results of the training on a cloud platform through quantum entanglement, sharing each layer of the concatenated layers through partial domain adaptation, saving each layer of the concatenated layers locally, and in response to a layer being updated through entanglement, including weights associated with the layer.

Additionally, it is understood from the foregoing description that embodiments of the invention provide for entangled model weights from custom weights on the cloud, external local feature diffusion into an active deep learning algorithm, chained polymorphic shared layers through the cloud, and partial domain adaptation of polymorphic layers.

In embodiments, a service provider could offer to perform the processes described herein. In this case, the service provider can create, maintain, deploy, support, etc., the computer infrastructure that performs the process steps of the invention for one or more customers. These customers may be, for example, any business that uses cloud computing technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
selecting, by a computing device, layers from a plurality of external deep learning models;
concatenating, by the computing device, the selected layers from the plurality of external deep learning models to form a core deep learning model;
training, by the computing device, the core deep learning model; and
synchronizing, by the computing device, layers in the core deep learning model with the layers from the plurality of external deep learning models using quantum entanglement.

2. The method according to claim 1, wherein the layers from the plurality of external deep learning models are gated recurrent units.

3. The method according to claim 1, further comprising testing, by the computing device, the layers from the plurality of external deep learning models using unseen patterns.

4. The method according to claim 3, wherein the layers from the plurality of external deep learning models are selected based on a result of the testing.

5. The method according to claim 1, further comprising storing, by the computing device, weights used in the core deep learning model.

6. The method according to claim 5, further comprising receiving, by the computing device, new incoming weights from the external deep learning models.

7. The method according to claim 6, wherein the synchronizing the layers in the core deep learning model with the layers from the plurality of external deep learning models using quantum entanglement comprises updating the weights used in the core deep learning model by combining the new incoming weights with the stored weights.

8. The method according to claim 7, further comprising using, by the computing device, a time weight factor to combine the new incoming weights with the stored weights.

9. A computer program product comprising a computer readable storage medium having program instructions embodied therewith, the program instructions executable by a computing device to cause the computing device to:
select layers from a plurality of external deep learning models based on testing using unseen patterns;
concatenate the selected layers from the plurality of external deep learning models to form a core deep learning model; and
synchronize layers in the core deep learning model with the layers from the plurality of external deep learning models using quantum entanglement.

10. The computer program product according to claim 9, wherein the layers from the plurality of external deep learning models are gated recurrent units.

11. The computer program product according to claim 9, the program instructions further being executable by the computing device to cause the computing device to determine a confidence score for each of the layers from the plurality of external deep learning models based on the testing using the unseen patterns.

12. The computer program product according to claim 11, the program instructions further being executable by the computing device to cause the computing device to select the layers from the plurality of external deep learning models based on the confidence score for each of the layers exceeding a predetermined threshold.

13. The computer program product according to claim 9, the program instructions further being executable by the computing device to cause the computing device to store weights used in the core deep learning model.

14. The computer program product according to claim 13, the program instructions further being executable by the computing device to cause the computing device to receive new incoming weights from the external deep learning models.

15. The computer program product according to claim 14, wherein the synchronizing the layers in the core deep learning model with the layers from the plurality of external deep learning models using quantum entanglement comprises updating the weights used in the core deep learning model by combining the new incoming weights with the stored weights.

16. The computer program product according to claim 15, the program instructions further being executable by the computing device to cause the computing device to use a time weight factor to combine the new incoming weights with the stored weights.

17. A system comprising:
a hardware processor, a computer readable memory, and a computer readable storage medium associated with a computing device;
program instructions to select layers from a plurality of external deep learning models;
program instructions to concatenate the selected layers from the plurality of external deep learning models to form a core deep learning model;
program instructions to train the core deep learning model; and
program instructions to synchronize layers in the core deep learning model with the layers from the plurality of external deep learning models using quantum entanglement,
wherein the program instructions are stored on the computer readable storage medium for execution by the hardware processor via the computer readable memory.

18. The system according to claim 17, wherein the layers from the plurality of external deep learning models are gated recurrent units.

19. The system according to claim 17, further comprising program instructions to test the layers from the plurality of external deep learning models using unseen patterns.

20. The system according to claim 17, wherein the layers from the plurality of external deep learning models are selected based on a result of the testing.

21. The system according to claim 17, further comprising program instructions to store weights used in the core deep learning model.

22. The system according to claim 21, further comprising program instructions to receive new incoming weights from the external deep learning models.

23. The system according to claim 22, wherein the synchronizing the layers in the core deep learning model with the layers from the plurality of external deep learning models using quantum entanglement comprises updating the weights used in the core deep learning model by combining the new incoming weights with the stored weights.

24. A method comprising:
concatenating, by a computing device, at least two gated recurrent units from at least two deep learning models to form a core deep learning model;
performing partial domain adaptation, by the computing device, on the core deep learning model; and
updating, by the computing device, weights used in the core deep learning model by combining new incoming weights from the at least two deep learning models with stored weights for the core deep learning model.

25. A computer program product comprising a computer readable storage medium having program instructions embodied therewith, the program instructions executable by a computing device to cause the computing device to:
concatenate at least two gated recurrent units from at least two deep learning models to form a core deep learning model;
perform partial domain adaptation on the core deep learning model;
store weights used in the core deep learning model; and
update weights used in the core deep learning model by combining new incoming weights from the at least two deep learning models with the stored weights.
